(19) United States
(12) Patent Application Publication
(10) Pub. No.: US 2009/0159584 A1
(43) Pub. Date: Jun. 25, 2009

(54) Cooking Appliance which is Mounted in an Elevated Manner

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Günter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch and Siemens Hausgeraete GmbH, Muenchen (DE)

(21) Appl. No.: 11/992,220

(22) PCT Filed: Sep. 11, 2006
(86) PCT No.: PCT/EP2006/066245

§ 371 Date: Mar. 18, 2008

(30) Foreign Application Priority Data
Sep. 19, 2005 (DE) 102005044689.2

(51) Int. Cl. F27B 5/14

(52) U.S. Cl. 219/390

(57) ABSTRACT

A cooking appliance which is mounted in an elevated manner, which comprises at least one muffle which defines a cooking chamber and which comprises a muffle opening which is on the base thereof, a base door which can be displaced and which is used to close the muffle opening, comprising at least one heating field on the upper side thereof and at least one operational state for the open state, wherein the heating field is at least partially connected. The cooking appliance which is mounted in an elevated manner comprises a displacing locking device, which prevents the open base door from being displaced when in the activated operational mode for the open state.

The invention relates to a built-in high-level cooking appliance with at least one muffle enclosing a cooking chamber and having an opening in its base, a movable base door for closing the muffle opening, said door incorporating at least one cooktop on its upper side and having at least one open-state operating mode in which the cooktop is at least partially ON. The present invention also relates to an associated operating method.

Publication DE 100 59 652 A1, for example, discloses such a built-in high-level cooking appliance in which the base door can be switched between stove top operation and oven base heating mode.

The disadvantage of the known designs is that the base door can be moved regardless of the operating state. This can cause cookware that is being heated with the base door in the open state to tip over when the door is moved, thereby spilling food. It can also happen that, when the base door is moved to the closed position, the cookware becomes trapped between base door and housing, since in the open state the cookware may project beyond the dimensions of the muffle.

The object of the present invention is to make it possible for the cooking appliance to be operated safely with the base door open.

This object is achieved by the built-in high-level cooking appliance as claimed in claim I and a method as claimed in claim 11. Advantageous embodiments are detailed individually or in combination in the sub-claims.

The generic built-in high-level cooking appliance has a movement lockout which prevents the open base door from being moved while an open-state operating mode is activated.

The movement lockout can be electrical, electronic (e.g. in a control circuit), mechanical or a combination thereof. The cooking appliance according to the invention is not limited to a motor operated base door, but is also applicable to electromechanical or purely mechanically operated doors. For example, in the case of a purely mechanically movable base door, the movement lockout can block the movement mechanism, e.g. by extending bolts into a lifting linkage. An activated operating mode means that the base door cooktop is at least partially ON—e.g. independently of a control program.

When a drive device controlled by a control device is present it is advantageous if the control device deactivates the drive device, typically the drive motor, while an open-state operating mode is activated.

It is then advantageous if the control device de-energizes, e.g. short-circuits, the drive device. However, other measures can be additionally or alternatively provided, e.g. deactivation of safety signals, deactivation of up/down movement relays.

For increased user safety it is advantageous if the movement lockout includes deactivation of at least one up/down switch, or even better: all the up/down switches.

The operating mode for the open state can be e.g. a warming mode, a cooking zone mode or a roaster mode.

It is also advantageous if, when the door is in the open state, only operating modes for the open state can be selected.

For operating convenience it may also be advantageous if the movement lockout only prevents the open base door from being moved when the cooktop is activated. The cooktop can be activated when it is ON (supplied with current) and/or it has a temperature above a particular value.

For ease of operation it is advantageous if, conversely, the base door can be moved when an operating mode for the closed state is activated. For example, the user can then open the cooking chamber by moving the base door in the open direction in order to check the consistency of the food being cooked, e.g. by pricking it, and then closing the base door again to allow it to cook further.

The built-in high-level cooking appliance will now be described in detail with reference to the accompanying schematics in which:

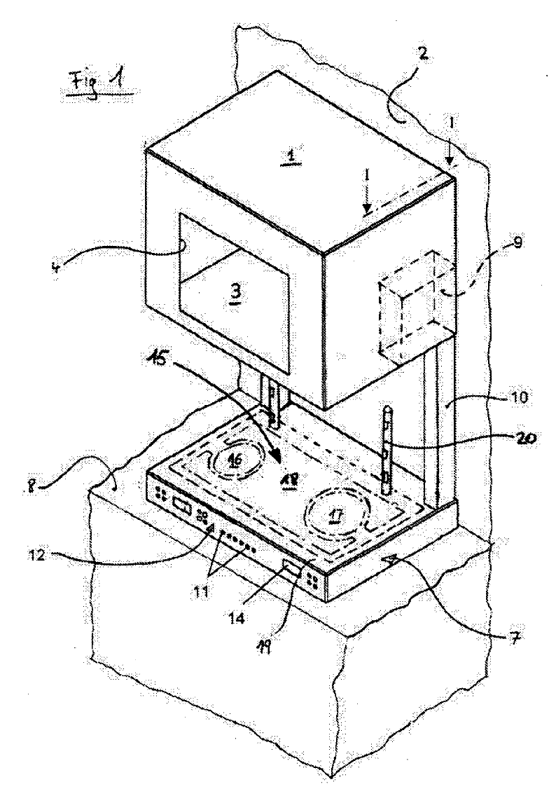

FIG. 1 shows a perspective view of a wall-mounted built-in high-level cooking appliance with the base door lowered;

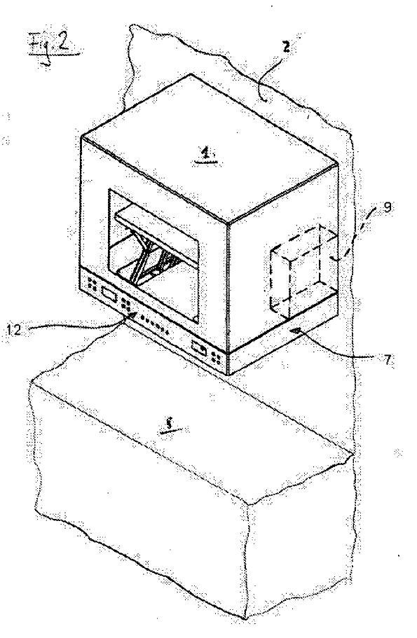

FIG. 2 shows a perspective view of a built-in high-level cooking appliance with the base door closed;

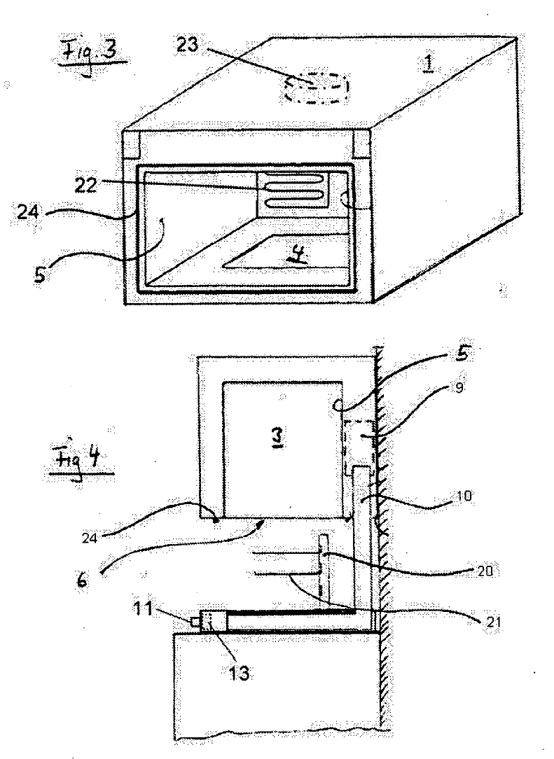

FIG. 3 shows a perspective view of a housing of the built-in high-level cooking appliance without the base door;

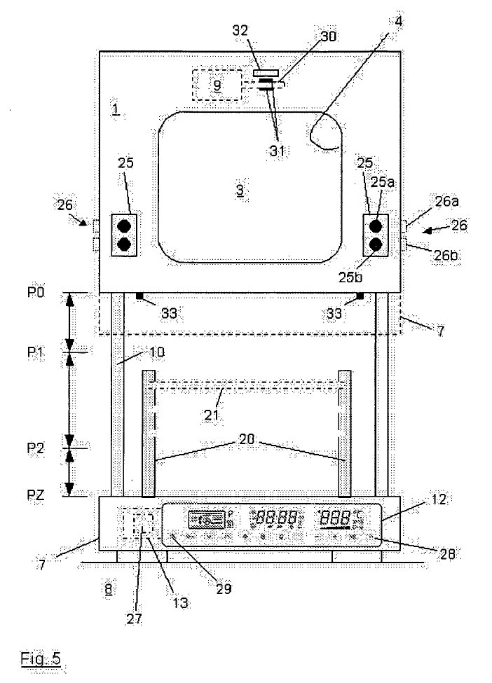

FIG. 4 shows a schematic side view in cross section along the line I-I from FIG. 1 of the wall-mounted built-in high-level cooking appliance with base door lowered;

FIG. 5 shows a front view of another embodiment of a built-in high-level cooking appliance;

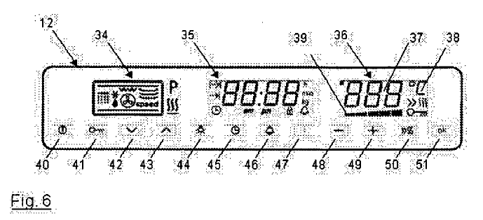

FIG. 6 shows a view of an operator panel of a built-in high-level cooking appliance.

To allow better representation of the individual elements, the figures are not drawn to scale.

FIG. 1 shows a built-in high-level cooking appliance with a housing 1. The back of the housing 1 is mounted on a wall 2 in the manner of hanging cabinet. In the housing 1 a cooking chamber 3 is defined which can be inspected through a viewing window 4 on the front of the housing 1. From FIG. 4 it can be seen that the cooking chamber 3 is delimited by a muffle 5 which is provided with heat insulating cladding, and that the muffle 5 has an opening 6 in its base. The muffle opening 6 can be closed with a base door 7. In FIG. 1 the base door 7 is shown in the lowered position with its underside resting on a countertop 8 of a kitchen unit. In order to close the cooking chamber 3, the base door 7 must be moved to the position shown in FIG. 2, the so-called “zero position”. To move the base door 7 the built-in high-level cooking appliance has a drive device 9, 10. The drive device 9, 10 has a drive motor 9 represented by dashed lines in FIGS. 1, 2 and 4 which is disposed between the muffle 5 and an outer wall of the housing 1. The drive motor 9 is disposed in the region of the back of the housing 1 and, as shown in FIG. 1 or 4, is operatively connected to a pair of lifting elements 10 which are connected to the base door 7. As shown in the schematic side view in FIG. 4, each lifting element 10 is implemented as an L-shaped support whose vertical leg extends out from the drive motor 9 on the side of the housing. To move the base door 7, the drive motor 9 can be actuated using a operator panel 12 and a control circuit 13 disposed on the front of the base door 7 as illustrated in FIGS. 1 and 2. As shown in FIG. 4, the control circuit 13 is located behind the operator panel 12 inside the base door 7. The control circuit 13, which here comprises a plurality of physically and functionally separate circuit boards communicating via a communications bus, constitutes a central control unit for appliance operation which controls, in an open and/or closed loop manner, e.g. heating, movement of the base door 3, implementation of user inputs, lighting, anti-trap protection, cycling of the heating elements 16, 17, 18, 22 and much more besides.

FIG. 1 shows that the upper side of the base door 7 has a cooktop 15. Virtually the entire surface area of the cooktop 15 is taken up by heating elements 16, 17, 18 which are indicated by dash-dotted lines in FIG. 1. In FIG. 1 the heating elements 16, 17 are two separate cooking zone heating elements of different sizes, while the heating element 18 is a large-area heating element provided between the two cooking zone heating elements 16,17 and virtually surrounds said cooking zone heating element 16, 17. The cooking zone heating elements 16, 17 define the user's cooking zones or “burners”; the cooking zone heating elements 16, 17 together with the large-area heating element 18 define an oven base heating zone. The zones can be indicated by suitable colors/patterning on the surface. The heating elements 16, 17, 18 can be controlled via the control circuit 13.

In the exemplary embodiment shown, the heating elements 16, 17, 18 are implemented as radiant heating elements which are covered by a glass ceramic panel 19. The glass ceramic panel 19 has approximately the dimensions of the upper side of the base door 7. The glass ceramic panel 19 is also fitted with mounting holes (not shown) through which sockets for mounting supports 20 for oven shelves 21 project, as also shown in FIG. 4. Instead of a glass ceramic panel 19, other—preferably fast reacting—covers can be used, e.g. a thin steel sheet.

A control knob provided in the operator panel 12 can be used to switch the built-in high-level cooking appliance to cooking zone or oven base heating mode which will be explained below.

In cooking zone mode, the cooking zone heating elements 16, 17 can be individually controlled via the control circuit 13 by means of controls 11 provided on the operator panel 12, while the large-area heating element 18 remains inoperative. Cooking zone mode can be effected with the base door 7 lowered, as shown in FIG. 1. However, this mode is also possible in an energy saving function with the base door 7 raised and the cooking chamber 3 closed.

In oven base heating mode, not only the cooking zone heating elements 16, 17 but also the large-area heating element 18 are controlled by the control device 13.

In order to achieve as uniform browning as possible during oven base heating mode, it is critical that the cooktop 15 providing the oven base heating produces a heat output that is evenly distributed over the surface area of the cooktop 15, even though the heating element 16, 17, 18 have different rated outputs. The heating elements 16, 17, 18 are not therefore switched to continuous operation by the control circuit 13, but power is supplied to the heating elements 16, 17, 18 in a cyclic manner. In this way the different nominal outputs of the heating element 16, 17, 18 are individually reduced such that the heating elements 16, 17, 18 provide a heat output that is evenly distributed over the surface area of the cooktop 15.

FIG. 3 schematically illustrates the position of an air circulating unit 23 comprising an air circulating fan motor and an assigned ring heating element, e.g. for producing hot circulating air for convection cooking. The air circulating unit 23 which is open to the cooking chamber 3 is typically separated from same by an impingement wall (not shown). Mounted to an upper side of the muffle 5 there is additionally provided a top heating element 22 which can be of single- or multi-circuit design, e.g. with an inner and an outer circuit. The different operating modes, such as top heating, convection or high-speed heating, for example, can be set by the control circuit 13 by appropriate switching-on and adjustment of the heat output of the heating elements 16, 17, 18, 22, possibly with activation of the hot air blower 23. The heat output can be adjusted by suitable cycling. In addition, the cooktop 15 can also be of a different design, e.g. with or without roaster zone, as a pure—single- or multi-circuit—warming zone without cooking zones, etc. The housing 1 has a seal 24 against the base door 7.

The operator panel 12 is disposed mainly on the front of the base door 7. Alternatively, other arrangements are also conceivable, e.g. on the front of the housing 1, split between different panel sections and/or partly on lateral surfaces of the cooking appliance. Further configurations are possible. The controls 11 are not limited in terms of their design and can comprise e.g. control knobs, toggle switches, pushbuttons and membrane keys, and the displays 14 include e.g. LED, LCD and/or touch screen indicators.

FIG. 5 is a schematic and not-to-scale front view of a built-in high-level cooking appliance in the open state with the base door 7 resting on the countertop 8. The closed state is indicated by a dashed line.

In this embodiment, two up/down switch panels 25 are located on the front of the fixed housing 1. Each up/down switch panel 25 comprises two pushbuttons, namely an upper CLOSE button 25a for moving the base door 7 in the closing direction and a lower OPEN button 25b for moving the base door 7 in the opening direction. Unless automatic mode (see below) is selected, the base door 7 is moved up, if this is possible, only if the CLOSE buttons 25a of both up/down switch panels 25 are continuously pressed simultaneously; the base door 7 is moved down, if this is possible, only if the OPEN buttons 25a of both up/down switch panels 25 are continuously pressed simultaneously (manual mode). Since in manual mode the person operating the appliance exercises greater attention and is also using both hands in this case, anti-trap protection is then optional. In an alternative embodiment, up/down switch panels 26 are mounted on opposite outer sides of the housing I with appropriate CLOSE buttons 26a and OPEN buttons 26b, as shown by dotted lines.

When an open-state operating mode is activated, a movement lockout implemented in the control circuit 13 prevents the open base door 7 from being moved, but does not do so when a closed-state operating mode is activated.

The dash-dotted control circuit 13 located inside the base door 7 behind operator panel 12 switches the drive motor 9 so as to soft-start the base door 7, i.e. not abruptly by simply starting up the drive motor 9, but by means of a defined ramp.

In this exemplary embodiment, the control circuit 13 comprises a memory unit 27 for storing at least one target or more specifically travel position P0, P1, P2, PZ of the base door 7, preferably using volatile memory devices, e.g. DRAMs. When a target position P0, P1, P2, PZ has been stored, the base door can be automatically moved in the direction set after actuating one of the keys 25a, 25b and 26a, 26b of the up/down switch panels 25 and 26 respectively until the next target position has been reached or one of the keys 25a, 25b or 26a, 26b is actuated again (automatic mode). In this exemplary embodiment the lowest target position PZ corresponds to maximum opening, the (zero) position P0 to the closed state, and P1 and P2 are freely settable intermediate positions. If the last target position for one direction is reached, further travel must take place in manual mode if this is possible (i.e. if the last end positions do not correspond to the fully open or the closed end state). Similarly, if no target position has been stored for a direction—which would be the case, for example, for raising the door to the closed position if only PZ is stored but not P0, P1, P2—movement in this direction must take place in manual mode. If no target position has been stored, e.g. at initial installation or after a power outage, no automatic operation is possible. If the base door 7 is moved in automatic mode, anti-trap protection is preferably activated.

Automatic operation and manual operation are not mutually exclusive: by continuously actuating the up/down switch panel(s) 25,26, the base door 7 is moved in manual mode even if it were possible to move to a target position in that direction. For example, a maximum actuation time of the up/down switch panels 25 and 26, or more specifically of the associated keys 25a, 25b and 26a, 26b respectively, can be specified for activating automatic mode, e.g. 0.4 seconds.

A target position P0, P1, P2, PZ can be any position of the base door 7 between and including the zero position P0 and the maximum open position PZ. However, the maximum open position PZ stored need not be the position resting on the countertop 8. Storing of the target position P0, P1, P2, PZ can be carried out with the base door 7 at the desired target position P0, P1, P2, PZ by e.g. actuating a confirmation key 28 in the operator panel 12 for several seconds (e.g. two seconds). Visual and/or audible signal generators present which emit appropriate signals when a target position has been stored are not shown in the drawings for the sake of clarity. Movement to the target position P0, P1, P2, PZ to be set is initiated by—in this example—two-handed operation of the up/down switch panels 25 and 26 and manual movement to this position.

Only one or, as shown in this exemplary embodiment, a plurality of target positions P0, P1, P2, PZ can be stored in the memory unit 27. In the case of several target positions P0, P1, P2, PZ, these can be moved in succession by actuating the corresponding travel keys 25a, 25b or 26a, 26b. A plurality of target positions P0, P1, P2, PZ enables the built-in high-level cooking appliance to be conveniently adapted to the operating height of a plurality of users. The target position(s) are advantageously deletable and/or overwritable. In one embodiment, for example, a single target position is storable in the open state, while the zero position P0 is automatically detected and can be moved to automatically. Alternatively, the zero position P0 must also be stored to enable it to be moved to automatically.

It is particularly advantageous for ergonomic use if the target position(s) P1, P2, PZ open the base door 7 at least approximately 400 to approximately 540 mm (i.e. P1-P0, P2-P0, PZ-P0≧40 cm to 54 cm). At this amount of opening the oven shelves 21 can be easily inserted in the supports 20, it being advantageous if the viewing window 4 is mounted approximately at the user's eye level or somewhat lower, e.g. by means of a template indicating the dimensions of the cooking appliance.

Not shown in the drawings is a power failure buffer providing a hold-up time of approximately 1 to 3 s, preferably up to 1.5 s.

The drive motor 9 from FIG. 1 has at least one sensor unit 31, 32 disposed on a motor shaft 30, possibly before or after a gear, in order to measure a displacement and a position and/or a speed of the base door 7. The sensor unit can comprise, for example, one or more induction, Hall effect, optical, SAW sensors, etc. Here, for simple displacement and speed measurement, two Hall (sub-)elements 31 offset by 180°—i.e. opposite one another—are mounted to the motor shaft 30, and a Hall sensor 32 is mounted at a fixed distance from this region of the motor shaft. If a Hall element 31 then passes the sensor 32 during rotation of the motor shaft 30, a measurement or rather sensor signal is produced which is digital to a good approximation. With (not necessarily) two Hall elements 31, two signals are produced for one revolution of the motor shaft 30. By means of time domain analysis of these signals, e.g. their time difference, the velocity vL of the base door 7 can be determined, e.g. via comparison tables or real time conversion in the control circuit 13. A displacement and a position of the base door 7 can be determined by, respectively, addition and subtraction of the measurement signals.

A speed control loop can implement the speed via a PWM-controlled power semiconductor for instance.

For zero point determination, the displacement measurement is automatically re-calibrated to the zero position P0 of the base door 7 at each startup so that e.g. an incorrectly transmitted or received sensor signal is not passed on.

The drive motor 9 can be operated by actuating the two up/down switch panels 25, 26 even with the master switch 29 in the OFF position.

Instead of two separate switches for each panel 25, 26, a single switch for each panel is also possible, e.g. a toggle switch with neutral position which only switches when pressed. Other forms are also possible, nor is there any restriction on the type and arrangement of the controls 28,29 of the operator panel 12.

The arrangement and subdivision of the control circuit 13 is flexible and unrestricted. It can therefore also comprise a plurality of circuit boards, e.g. a display board, a control board and a lift board which are physically separated from one another.

A 4 mm amount of opening can be detected by limit switches 33 which, when actuated, deactivate anti-trap protection.

The built-in high-level cooking appliance can also be implemented without a memory unit 27, no automatic operation then being possible. This may be advisable for increased user safety, e.g. as anti-trap protection.

When an operating mode for the open state is activated (e.g. e.g. cooking zone, warming or roaster mode), in one embodiment the control circuit 13 can prevent movement of the base door 7 by deactivating—in this case short-circuiting—the drive motor 9. When an operating mode for the closed state is activated, the base door 7 can be lowered to allow the cooking food to be checked.

FIG. 6 shows the operator panel 12 from FIG. 5 in greater detail. The operator panel 12 comprises a left display section 34, a center display section 35 and a right display section 36 which in this Figure display all the possible indications, such as e.g. in the left display section 34: operating mode symbols; in the central section 35: the time of day, cooking time or other parameters useful for the mode selected; and in the right section 36: a three-digit alphanumeric indication 37, a unit-of-temperature indication 38 (which can be set here to ° C. and ° F.) and a progress indication 39. The operator panel can be connected such that, when the base door is in the open state, only open-state operating modes are displayed and/or when the base door is in the closed state, only closed-state operating modes are displayed. Located therebelow are a row of switches 40-51, namely
a master switch button 40 for switching the appliance on and off, possibly with a time delay,
a key button 41 for locking the appliance,
an arrow-down button 42 for selecting individual operating modes in descending sequence, this button can be connected in such a way that, when the base door is in the open state, only open-state operating modes can be selected and/or when the base door is in the closed state, only closed-state operating modes can be selected;
an arrow-up button 43 for selecting individual operating modes in ascending sequence, this button can be connected in such a way that, when the base door is in the open state, only open-state operating modes can be selected and/or when the base door is in the closed state, only closed-state operating modes can be selected;
an oven lamp or a light switch 44 for active switching of the oven lighting (not shown) by the user,
timer button 45 for selecting individual timing functions, e.g. baking time, etc.,
an alarm button 46 for selecting an alarm function,
an information button 47 for calling up information, e.g. an actual temperature or a heat-up time,
a minus button 48 for decreasing the temperature setting and time functions,
a plus button 49 for increasing the temperature setting and time functions,
a fast heat-up button 50 for switching a fast heat-up function on and off, and
an OK button or confirmation button 51 as activation button e.g. for time functions and operating mode.

In this exemplary embodiment, the operating mode selection circuit therefore uses two separate arrow buttons 42,43 and if necessary the confirmation button 51. By actuating the operating mode selection circuit, the cooking appliance can be switched between different functionalities, the operating modes being run through cyclically. The operating mode selection circuit is not limited to the embodiment shown here.

The present invention is self-evidently not limited to the examples described, but extends over the entire scope of the claims.

### LIST OF REFERENCE CHARACTERS

1 housing
2 wall
3 cooking chamber
4 viewing window
5 muffle
6 muffle opening
7 base door
8 countertop
9 drive motor
10 lifting element
11 control
12 operator panel
13 control circuit
14 displays
15 cooktop
16 cooking zone heating element
17 cooking zone heating element
18 large-area heating element
19 glass ceramic panel
20 support
21 shelf
22 top heating element
23 fan
24 seal
25 up/down switch panel
25a up-switch
25b down-switch
26 up/down switch panel
26a up-switch
26b down-switch
27 memory unit
30 motor shaft
31 Hall element
32 sensor
33 limit switch
34 left display section
35 central display section
36 right display section
37 alphanumeric indication
38 unit-of-temperature indication
39 progress indication
40 master switch
41 key switch
42 arrow-down button
43 arrow-up button
44 oven lamp button
45 timer button
46 alarm button
47 information button
48 minus button
49 plus button
50 fast heat-up button
51 OK or confirmation button
52 operator panel
53 cooking zone switch
54 central display section
55 progress indication
56 alphanumeric indication
P0 zero position
P1 intermediate position
P2 intermediate position
PZ end position

1-12. (canceled)

13. A built-in high-level cooking appliance, comprising
a muffle delimiting a cooking chamber and having an opening in its base;
a movable base door for closing the muffle opening and having at least one cooktop on its upper side;
the base door having at least one open-state operating mode wherein the cooktop is at least partially on; and
a movement lockout apparatus, whereby when an open-state operating mode is activated, the movement lockout prevents the base door from being moved.

14. The built-in high-level cooking appliance as claimed in claim 13 further including a drive device and a control device; the drive device controlled by the control device for raising and/or lowering the base door; the control device deactivating the drive device when an open-state operating mode is activated.

15. The built-in high-level cooking appliance as claimed in claim 14 wherein the control device is capable of de-energizing the drive device.

16. The built-in high-level cooking appliance as claimed in claim 13 further including at least one up/down switch wherein the movement lockout apparatus being capable of deactivating the up/down switch.

17. The built-in high-level cooking appliance as claimed in claim 13 wherein the open-state operating mode is a warming mode.

18. The built-in high-level cooking appliance as claimed in claim 13 wherein the open-state operating mode is a cooking zone mode.

19. The built-in high-level cooking appliance as claimed in claim 13 wherein the open-state operating mode is a roaster mode.

20. The built-in high-level cooking appliance as claimed in claim 13 wherein the base door has an open state; when the base door is in the open state only open-state operating modes can be activated.

21. The built-in high-level cooking appliance as claimed in claim 13 whereby the movement lockout only prevents the base door from being moved when the cooktop is at least partially on.

22. The built-in high-level cooking appliance as claimed in claim 13 wherein the base door has a closed state operating mode; the base door is capable of being moved while the closed-state operating mode is activated.

23. A method for operating a built-in high level cooking apparatus which includes a muffle delimiting a cooking chamber and an opening in its base, and a movable base door for closing the muffle opening having at least one cooktop on its upper side comprising:
opening the base door;
activating an open state operating mode when the base door is open; and
preventing the base door from being moved at least when the cooktop is activated by operating a movement lockout.
